(19) United States
(12) Patent Application Publication
(10) Pub. No.: US 2015/0345958 A1
(43) Pub. Date: Dec. 3, 2015

(54) Method of Controlling an Auxiliary Vehicle System

(71) Applicant: ATIEVA, INC., Redwood City, CA (US)

(72) Inventor: Philip R. Graham, Milpitas, CA (US)

(73) Assignee: ATIEVA, INC., Redwood City, CA (US)

(21) Appl. No.: 14/288,007

(22) Filed: May 27, 2014

Related U.S. Application Data
(63) Continuation-in-part of application No. 14/287,696, filed on May 27, 2014.

(51) Int. Cl. G01C 21/34; B60W 50/00; G06Q 10/10; B60L 11/18

(52) U.S. Cl. CPC G01C 21/34; B60L 11/1874; B60L 11/1875; B60W 50/00; G06Q 10/1095

(57) ABSTRACT

A method of preparing a car for travel is provided. The system incorporates a user's calendar into the vehicle's navigation system, synchronizes the on-board calendar with the calendar contained on the user's device (e.g., cellular phone, laptop computer, tablet computer, personal digital assistant, computer system, etc.), determines the locations corresponding to each of the appointments contained on the calendar, estimates the travel time between locations, and determines appropriate departure times corresponding to each appointment on the calendar. Using this information, the system may be configured to automatically activate a thermal management system or other auxiliary system prior to an intended departure time.

### CROSS-REFERENCE TO RELATED APPLICATION

This application is a continuation-in-part of U.S. patent application Ser. No. 14/287,696, filed 27 May 2014, the disclosure of which is incorporated herein by reference for any and all purposes.

### FIELD OF THE INVENTION

The present invention relates generally to a vehicle and, more particularly, to a system that optimizes a vehicle's route based on the driver's schedule as well as a variety of other factors and conditions.

### BACKGROUND OF THE INVENTION

In today's fast-paced society, most people have very full schedules, often filled with client meetings, business appointments, school activities, and various social engagements. Electronic calendars are typically used to keep track of those events, regardless of whether those calendars are maintained on the user's smart phone, personal organizer, tablet computer, home computer or work computer. In those instances where multiple calendars are maintained, for example a phone-based calendar and a second calendar on a work computer, periodically the two calendars must be synchronized.

While maintaining an up-to-date electronic calendar can help to minimize the risk of completely missing an appointment, many people still find it difficult to be on time. This inability to be timely is often due to the many complexities associated with travel, complexities ranging from the time consuming task of inputting destination information into the vehicle's navigation system to changing traffic and weather conditions to a vehicle's finite driving range. The issue of finite driving range is further exacerbated for an electric vehicle (EV) where limited access to charging facilities as well as the time that it can take to charge an EV's battery pack can significantly impact a person's ability to be timely, especially if they have a crowded calendar. Accordingly, what is needed is a system that can help a person to manage their calendar when they are forced to travel between scheduled events. The present invention provides such a system.

### SUMMARY OF THE INVENTION

The present invention provides a method of controlling an auxiliary vehicle system, the method comprising the steps of (i) coupling a remote system (e.g., cellular phone, laptop computer, tablet computer, personal digital assistant, computer system, network-based computing system, etc.) to an on-board system controller, where the remote system is physically separate and independent of the vehicle; (ii) synchronizing the on-board calendar with a calendar contained on the remote system, where the calendar includes a plurality of successive appointments spanning a period of time, and where each appointment of the plurality of successive appointments has a corresponding appointment start time; (iii) determining a plurality of locations that correspond to the plurality of successive appointments; (iv) organizing the driving route, where the driving route includes the plurality of locations, and where the driving sequence of the driving route maintains the appointment sequence corresponding to the plurality of successive appointments; (v) estimating a plurality of successive drive times, where each of the plurality of successive drive times corresponds to a pair of successive appointments of the plurality of successive appointments; (vi) determining a plurality of successive departure times corresponding to the plurality of successive appointments and incorporating the plurality of successive drive times; and (vii) activating an auxiliary vehicle system a preset length of time prior to at least one of the plurality of successive departure times. The steps of determining the plurality of locations, organizing the driving route, estimating the plurality of successive drive times, determining the plurality of successive departure times, and activating the vehicle thermal management system may be performed by the on-board system controller. The preset length of time may be set by the vehicle's manufacturer, a third party or it may be user selectable. The vehicle thermal management system may be coupled to the vehicle's passenger cabin.

In one aspect, the vehicle is an electric vehicle (EV), and the step of activating the auxiliary vehicle system further comprises the step of activating a battery pack cooling subsystem thermally coupled to a vehicle battery pack, where the battery pack is electrically coupled to the vehicle's propulsion motor. The method may further include the steps of monitoring the battery pack's current temperature, comparing the battery pack's current temperature to a preferred temperature range, and only activating the battery pack cooling subsystem if the current battery pack temperature exceeds the preferred temperature range. Additionally, the method may further include the step of determining if the EV is plugged into an external charging source and only activating the battery pack cooling subsystem when the EV is plugged into an external charging source.

In another aspect, the vehicle is an electric vehicle (EV), and the step of activating the auxiliary vehicle system further comprises the step of activating a battery pack heating subsystem thermally coupled to a vehicle battery pack, where the battery pack is electrically coupled to the vehicle's propulsion motor. The method may further include the steps of monitoring the battery pack's current temperature, comparing the battery pack's current temperature to a preferred temperature range, and only activating the battery pack heating subsystem if the current battery pack temperature is lower than the preferred temperature range. Additionally, the method may further include the step of determining if the EV is plugged into an external charging source and only activating the battery pack heating subsystem when the EV is plugged into an external charging source.

In another aspect, the auxiliary vehicle system is comprised of a passenger cabin heating, ventilation and air conditioning system.

In another aspect, the auxiliary vehicle system is comprised of a vehicle lighting system.

In another aspect, the auxiliary vehicle system controls a plurality of vehicle windows.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a system level diagram of the primary EV systems utilized in at least one embodiment of the invention;

FIG. 2 provides a system level diagram of the primary systems utilized in at least one embodiment of the invention in which the system is integrated into an ICE-based vehicle;

FIG. 3 illustrates the basic methodology of the invention in accordance with a preferred embodiment;

FIG. 4 illustrates a modification of the basic methodology shown in FIG. 3;

FIG. 5 illustrates another modification of the basic methodology shown in FIG. 3;

FIG. 6 illustrates another modification of the basic methodology shown in FIG. 3;

FIG. 7 illustrates another modification of the basic methodology shown in FIG. 3; and

FIG. 8 illustrates another modification of the basic methodology shown in FIG. 3.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The term “battery pack” as used herein refers to one or more batteries electrically interconnected to achieve the desired voltage and capacity. The terms “electric vehicle” and “EV” may be used interchangeably and refer to an all-electric vehicle.

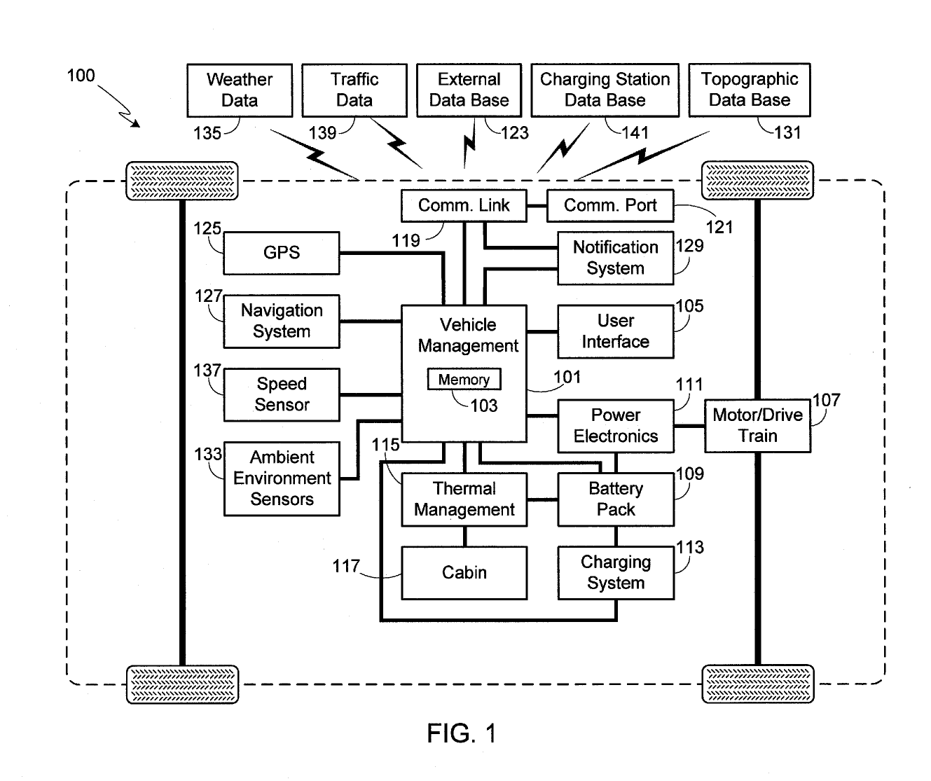

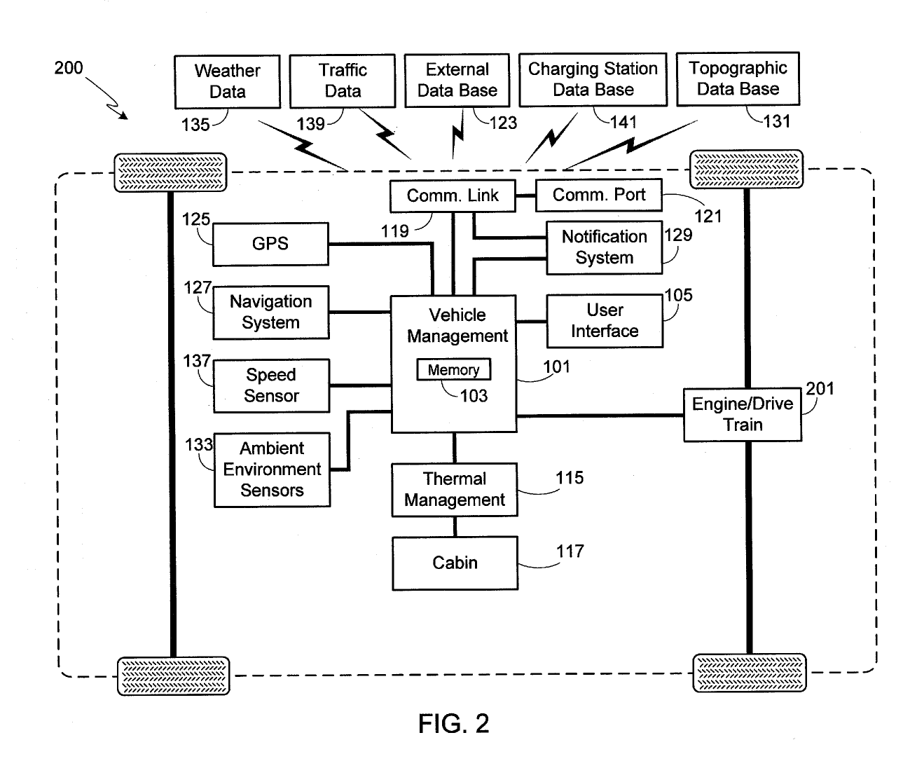

FIG. 1 is a high-level view of an EV 100 and the primary systems used in a route scheduling and optimization system in accordance with the invention. As described in further detail below with reference to FIG. 2, the invention may also be used with a vehicle utilizing an internal combustion engine (ICE), either alone or in combination with an electric motor (i.e., a hybrid). However, given the current scarcity of charging stations as well as the charging time required by many EV charging systems, the disclosed route planning and optimization system tends to be more beneficial to an EV driver than to someone driving an ICE or hybrid vehicle. It should be understood that the system configuration illustrated in FIGS. 1 and 2 is but one possible configuration and that other configurations may be used while still retaining the functionality of the invention. Additionally, one or more of the elements shown in FIGS. 1 and 2 can be grouped together in a single device, and/or circuit board, and/or integrated circuit.

EV 100 includes a vehicle system controller 101, also referred to herein as a vehicle management system, which is comprised of a central processing unit (CPU). System controller 101 also includes memory 103, with memory 103 being comprised of EPROM, EEPROM, flash memory, RAM, solid state drive, hard disk drive, or any other type of memory or combination of memory types. A user interface 105 is coupled to vehicle management system 101. Interface 105 allows the driver, or a passenger, to interact with the vehicle management system, for example inputting data into the navigation system, altering the heating, ventilation and air condition (HVAC) system, controlling the vehicle's entertainment system (e.g., radio, CD/DVD player, etc.), adjusting vehicle settings (e.g., seat positions, light controls, etc.), and/or otherwise altering the functionality of EV 100. Interface 105 also includes means for the vehicle management system to provide information to the driver and/or passenger, information such as a navigation map or driving instructions as well as the operating performance of any of a variety of vehicle systems (e.g., battery pack charge level for an EV, fuel level for an ICE-based vehicle, selected gear, current entertainment system settings such as volume level and selected track information, external light settings, current vehicle speed, current HVAC settings such as cabin temperature and/or fan settings, etc.). Interface 105 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Interface 105 may be comprised of a single interface, for example a touch-screen display, or a combination of user interfaces such as push-button switches, capacitive switches, slide or toggle switches, gauges, display screens, warning lights, audible warning signals, etc. It will be appreciated that if user interface 105 includes a graphical display, controller 101 may also include a graphical processing unit (GPU), with the GPU being either separate from or contained on the same chip set as the CPU.

EV 100 includes one or more motors 107 that provide vehicle propulsion. Motor(s) 107 may be mechanically coupled to the front axle/wheels, the rear axle/wheels, or both, and may utilize any of a variety of transmission types (e.g., single speed, multi-speed) and differential types (e.g., open, locked, limited slip). Battery pack 109, which may be comprised of one or hundreds or thousands of rechargeable batteries, supplies the power necessary for operation of motor(s) 107. Additionally, battery pack 109 may provide the power necessary for the various vehicle systems that require electrical power (e.g., lights, entertainment systems, navigation system, etc.). Typically battery pack 109 is coupled to motor(s) 107 via a power control system 111 that insures that the power delivered to the drive motor is of the proper form (e.g., correct voltage, current, waveform, etc.).

Battery pack 109 is charged by charging system 113. Charging system 113 may either be integrated into EV 100 as shown, or be comprised of an external charging system. Typically charging system 113 is configured to be electrically connected to an external power source, not shown, such as the municipal power grid. Battery pack 109 may also be charged, at least in part, using an on-board system such as a regenerative braking system.

EV 100 also includes a thermal management system 115. Thermal management system 115, which includes both a heating subsystem and a cooling subsystem, is used to insure that the batteries within battery pack 109 are maintained within the desired operating, charging and/or storage temperature range. Preferably thermal management system 115 is also coupled to the HVAC system used to maintain the passenger cabin within the desired temperature range.

Coupled to vehicle management system 101 is a communication link 119. Communication link 119 may be used to wirelessly obtain configuration updates or other information from an external data source (e.g., manufacturer, dealer, service center, web-based application, remote home-based system, third party source, etc.) using any of a variety of different technologies (e.g., GSM, EDGE, UMTS, CDMA, DECT, WiFi, WiMax, etc.). In some embodiments, communication link 119 may also include an on-board port 121, such as a USB, Thunderbolt, or other port, in order to receive updates and information over a wired communication link.

FIG. 2 provides a high-level view of a second vehicle configuration, integrated into an ICE-based vehicle, suitable for use with the route scheduling and optimization system of the invention. As shown, motor 107 of vehicle 100 is replaced in vehicle 200 with engine 201. Due to the use of engine 201, vehicle 200 does not include battery pack 109, power electronics subsystem 111 or charging system 113. It will be appreciated that the invention is equally applicable to a hybrid vehicle.

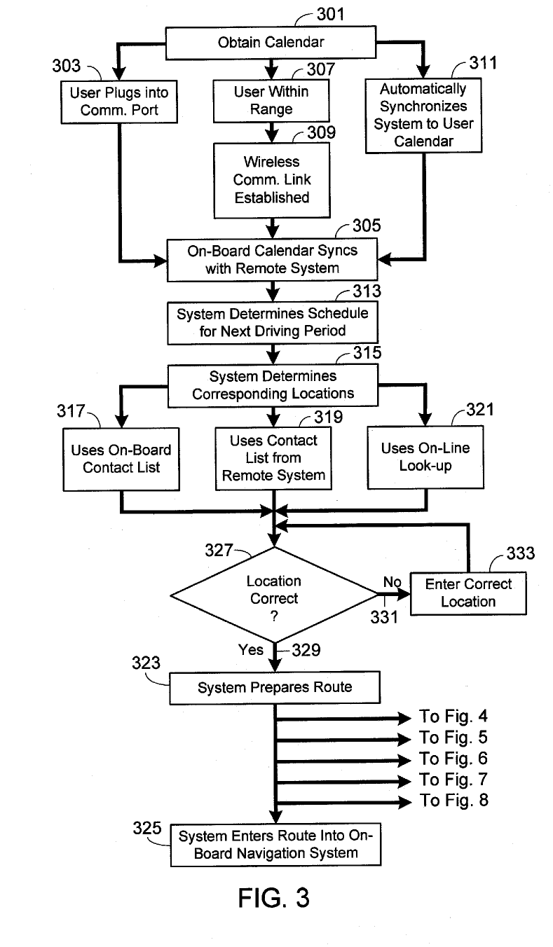

FIG. 3 illustrates the basic methodology of the invention in accordance with at least one embodiment of the invention. Initially the system obtains the schedule for the next driving period (step 301). Typically the next driving period is defined as the next day since it is assumed that the car can be charged, or re-fueled, as necessary while the driver rests. In some embodiments, however, the schedule is obtained for a longer period of time, e.g., a week or a month, thus providing additional time to resolve any potential scheduling problems identified by the system.

Schedule information may be obtained in a variety of ways. In at least one embodiment, the system is only configured to allow the schedule information to be obtained using one of the identified techniques, while in other embodiments the system is configured to allow schedule information to be obtained using any of a variety of techniques. In one technique, when the user plugs their smartphone or other compatible device into port 121 (step 303), the system automatically synchronizes the calendar on the user's device with the on-board calendar (step 305). In an alternate technique, when the user comes into close proximity to the vehicle (step 307), for example by entering and sitting in the vehicle, a short range link is established between the user's smartphone or other compatible device and the on-board system using communication link 119 (step 309), for example using Bluetooth or similar short range wireless technology. Once the user's device and the on-board system are linked, the system automatically synchronizes the calendar on the user's device with the on-board calendar (step 305). In an alternate technique, the on-board system periodically connects via communication link 119 with a remote system that contains the user's calendar (step 311). The system may be configured to allow the timing period for establishing the communication link to be set by the vehicle's manufacturer, a third party such as a service technician, or by the end user. Typically the timing period is set for once or twice a day, or once or twice an hour, although preferably other periods may be selected. In this technique the communication link is established using a long range wireless technology and as such, may be used to connect to the user's smartphone, tablet, personal digital assistant (PDA), home computer, work computer, or to a network-based system (e.g., server). Each time that a communication link is established, the system automatically synchronizes the calendar on the remote system with the on-board calendar (step 305).

Once system controller 101 has obtained and synchronized the user's calendar with the calendar maintained within the system (e.g., within memory 103), the system controller determines the schedule for the next driving period (step 313). Typically the system is configured to use the following day as the next driving period, although the system may be configured to allow the end user or a third party to preset the driving period for a different period of time, for example the next two days or the next week. After a schedule has been entered into the system, the controller determines the locations that correspond to each of the scheduled appointments (step 315).

If the user has not input a location into their calendar for some or all of the scheduled appointments, the system can determine the corresponding locations using any of a variety of techniques. In one technique, the system controller 101 searches an on-board contact list, for example a user contact list stored in memory 103, to find addresses for any scheduled appointment listed in the calendar that does not specify the appointment's location (step 317). Thus, for example, if the user has an appointment scheduled for 2 PM the following day with a Mr. John Doe, the system controller would search the contact list for John Doe in order to determine the appropriate address. In an alternate technique, when the system controller synchronizes the user's calendar with the on-board calendar (step 305), the controller also searches the contact data contained within the user's device or system for the addresses of the scheduled appointments (step 319). In an alternate technique, the system controller searches on-line (e.g., internet-based) data bases 123 for the address (step 321). Thus, for example, if the user has scheduled to meet Mr. Doe at restaurant X at 2 PM, the system controller would search for restaurants under that name. In those instances where there is more than one address listed under the searched name, as might be expected when searching for restaurants or similar commercial establishments, preferably the system controller would apply logic to determine the best fit, for example based on proximity to the user's home location or based on proximity to the vehicle's current location as provided by graphical positioning system (GPS) 125.

After the locations for the different appointments on the user's schedule have been identified, the system controller prepares a travel route for the selected driving period (step 323) and enters that route into the vehicle's navigation system 127 (step 325). Preferably if the system controller had to determine the location of one or more of the scheduled appointments as described above relative to steps 317, 319 and 321, then the system controller confirms the determined locations with the user (step 327) as shown in FIG. 3. For example, the system may request confirmation of the determined locations on the user interface 105, assuming that interface 105 includes a display. Alternately, in at least one embodiment the system controller sends a confirmation request to the user's smartphone or computer using notification system 129 and communication link 119. If the user confirms the locations (step 329), system controller determines the travel route (step 323) and enters the route into navigation system 127 (step 325). If the user indicates that a determined location is incorrect (step 331), the system controller allows the user to input the correct location (step 333), for example using their smartphone or computer or on-board interface 105. As noted above, once all locations are correctly identified, the system plans the travel route (step 323) and enters the route into navigation system 127 (step 325).

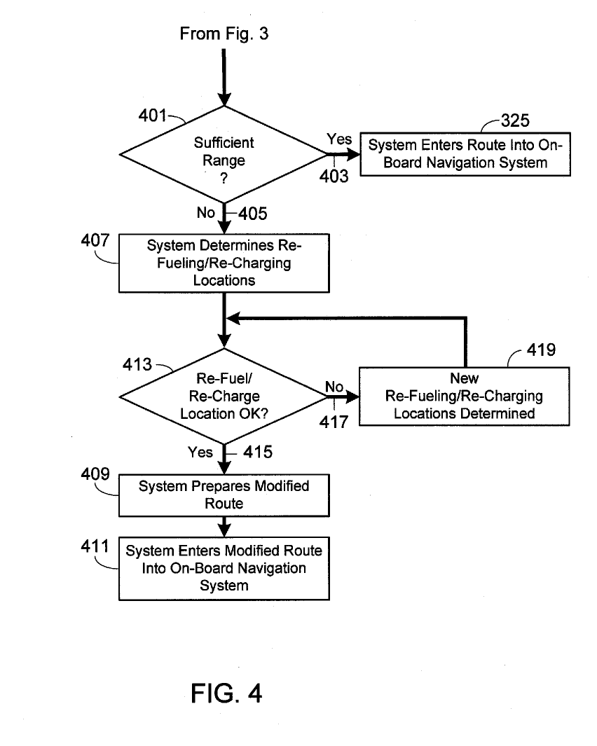

In at least one embodiment, the method shown in FIG. 3 is modified to include re-charging or re-fueling stops. As shown in FIG. 4, after the system has determined the route (step 323), system controller determines if the vehicle has sufficient range to travel the planned route (step 401). In determining whether or not the vehicle has sufficient range, the system controller may use either the current fuel or battery charge level, or it can be configured to assume a full tank of gas or a full battery charge. The system controller may also be configured to base driving range on an average miles per gallon (MPG) or miles per gasoline equivalent (MPGe) input into the system by the manufacturer; alternately, the system controller may use an average MPG or MPGe based on that particular vehicle's performance over a period of time (e.g., performance to date); alternately, the system controller may use an average MPG or MPGe modified to take into account current or expected driving conditions. Current and expected driving conditions may include:

Topography: the topography of the roads on the determined route may affect driving range. For example, extensive up-hill travel can be expected to lower the vehicle's MPG or MPGe. Although topography information may be stored within memory 103, typically system controller 101 will obtain this information using an external, on-line topographic data base 131.

Speed limits: the speed that the vehicle travels will affect the vehicle's efficiency. In determining range, the system controller may be configured to assume that the vehicle will travel at the speed limit. Alternately, the system controller may be configured to assume that the vehicle will travel a certain amount over or under the speed limit. Speed limit data may be stored in memory 103 or obtained on-line from external data base 123.

Weather conditions: the current weather conditions can affect travel speed, and thus vehicle efficiency and driving range. Accordingly, in determining range preferably system controller 101 reviews the weather conditions to determine if the weather may be expected to affect driving range. Current weather conditions may be obtaining using on-board sensors, such as precipitation and ambient temperature sensors 133. Alternately, or in addition to current weather data, the system controller may search on-line weather data bases 135 to obtain weather forecasts for the region and time of travel.

Traffic conditions: the current traffic conditions can affect travel speed, and thus vehicle efficiency and driving range. While current driving speed may be obtained using sensor 137, for route planning purposes historical traffic patterns are more important. Typically such historical traffic patterns may be obtained from an on-line data base 139 for a particular route and time of day.

Once the vehicle's driving range is known, the system controller can determine if the vehicle has sufficient range to travel the planned route (step 401). If the car has sufficient range (step 403), then the route is entered into the navigation system (step 325). If the car does not have sufficient driving range (step 405), then the system controller determines potential re-fueling (ICE based vehicle) or re-charging (EV) stations based on (i) remaining within a preset distance of the intended route and (ii) breaks (e.g., lunch) within the schedule of sufficient time to allow re-fueling/re-charging (step 407). In determining possible re-fueling or re-charging stations, the system controller may look at a station data base stored within memory 103, or a station data base stored within navigation system 127, or a charging station data base 141 stored on-line and retrieved via communication link 119.

After one or more re-fueling/re-charging breaks have been identified and added to the route, the system controller prepares a modified travel route for the selected driving period (step 409) and enters the modified route into the vehicle's navigation system 127 (step 411). Preferably prior to finalizing the modified route the system controller confirms the location and timing of the re-fueling/re-charging break with the user (step 413) as shown in FIG. 4. User confirmation may be requested via user interface 105; alternately, the controller can send a confirmation request to the user's smartphone or computer using notification system 129 and communication link 119. If the user confirms the location and timing of the re-fueling/re-charging break (step 415), the system controller determines the modified travel route (step 409) and enters the modified route into navigation system 127 (step 411). If the user indicates that the location and timing of the re-fueling/re-charging break is unacceptable (step 417), a new re-fueling/re-charging break is determined (step 419), preferably through selection by the user from a list of potential re-fueling/re-charging locations provided by the system controller. Once an acceptable re-fueling/re-charging location is identified, or the user over-rides the controller and accepts the original, non-modified route, then the system enters the route into navigation system 127 (step 411).

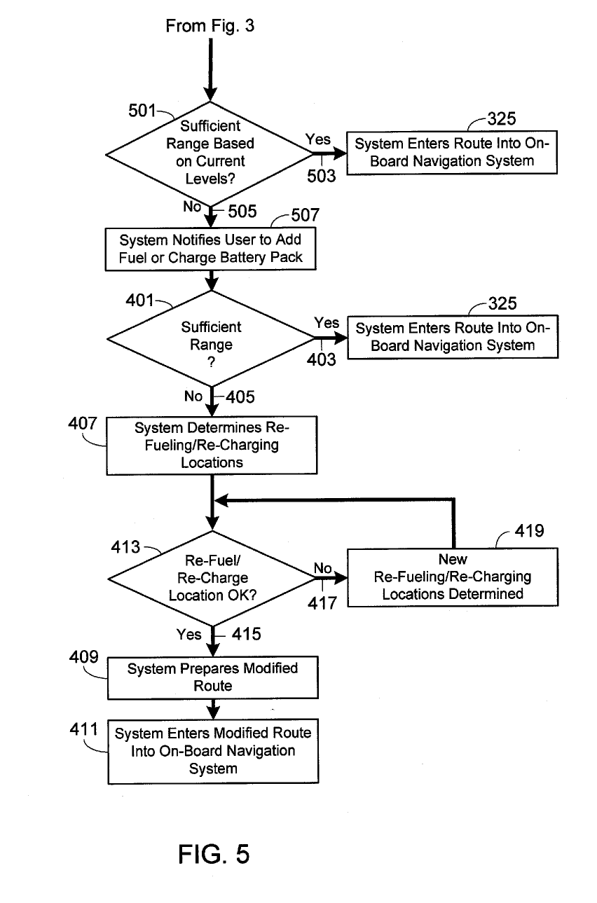

FIG. 5 illustrates a minor modification of the system shown in FIGS. 3 and 4. In step 501, after the system has determined the route (step 323), the system controller determines if the vehicle has sufficient range to travel the planned route based on the current fuel or battery charge level (step 501). Although not required by this method, preferably the system controller takes into account topography, speed limits, expected traffic conditions, and current and/or forecasted weather conditions as noted above. If the car has sufficient range based on the current fuel or battery charge level (step 503), then the route is entered into the navigation system (step 325). If the car does not have sufficient driving range (step 505), then the system controller notifies the user using notification system 129 that the car should be filled with gas, assuming an ICE-based car, or recharged, assuming an EV, the night before the scheduled travel is to take place (step 507). Notification may use interface 105; alternately, notification system 129 may text or email the notification to the user; alternately, notification system 129 may call the user and play a pre-recorded message when the phone is answered.

After notifying the user to add fuel or recharge their car the night before, preferably controller 101 then determines whether or not the vehicle has the driving range, assuming a full fuel tank or fully charged battery, to travel the planned route without re-fueling or re-charging (step 401). If the car has sufficient range (step 403), then the route is entered into the navigation system (step 325). If the car does not have sufficient driving range (step 405), then the system controller determines potential re-fueling (ICE based vehicle) or re-charging (EV) stations based on (i) the intended route and (ii) breaks (e.g., lunch) within the schedule of sufficient time to allow re-fueling/re-charging (step 407). In determining possible re-fueling or re-charging stations, the system controller may use on-board or on-line data bases as previously noted. Once re-fueling/re-charging times and places have been identified and added to the route, the system controller prepares a modified travel route for the selected driving period (step 409) and enters the modified route into the vehicle's navigation system 127 (step 411). As previously noted, preferably prior to finalizing the modified route the system controller confirms the location and timing of the re-fueling/re-charging break(s) with the user (step 413). If the user confirms the location and timing of the re-fueling/re-charging break (step 415), the system controller determines the modified travel route (step 409) and enters the modified route into navigation system 127 (step 411). If the user indicates that the location and/or timing of the re-fueling/re-charging break is unacceptable (step 417), a new re-fueling/re-charging break is determined (step 419), for example by the user selecting a re-fueling/re-charging location from a list of potential locations provided by the system controller. After an acceptable re-fueling/re-charging location is identified, the system prepares the modified route (step 409) and enters the modified route into navigation system 127 (step 411).

In at least one other embodiment, the method shown in FIG. 3 is modified to include schedule information with the route information, thereby helping the driver to make it to all of their appointments on time. Note that this scheduling information can also be added to the modified route determined in FIGS. 4 and 5.

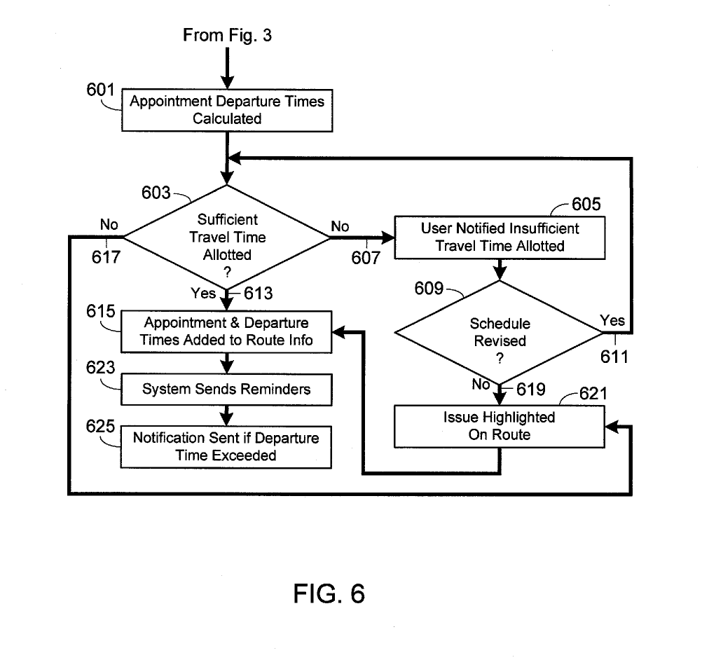

As shown in FIG. 6, after the system has determined the route (step 323), the system controller then determines departure times for each scheduled appointment (step 601). At a minimum, the departure times calculated by system controller 101 are based on a preset average speed and the distance to be traveled, i.e., from the previous appointment to the next appointment. Preferably, rather than use an average speed, system controller 101 assumes a specific speed limit for each type of road (e.g., rural road, city street, highway, etc.). More preferably, system controller determines the speed limit for each road for the next portion of the route, for example by querying an on-board data base in memory 103 or navigation system 127, or querying on-line data base 123. Still more preferably, system controller 101 determines departure times based on distance, speed limits, topography (e.g., from topographical data base 131), expected traffic conditions (e.g., from traffic data base 139), and current and/or forecasted weather conditions (e.g., from sensors 133 and/or weather data base 135).

After determining the departure time corresponding to each appointment, preferably the controller determines whether or not sufficient time has been left between consecutive appointments (step 603). In order to make this determination, controller 101 needs to know the length of time required for each appointment. In some cases that information may have been included in the calendar by the user, for example by reserving 1 hour for a specific appointment. In other instances, a default time period (e.g., 30 minutes, 1 hour, etc.) is used. While the default time period may be preset by the manufacturer, preferably it is adjustable by a third party, and more preferably it is adjustable by the end user. Once both the required departure time and the meeting length are known for each appointment, controller 101 is able to determine whether sufficient time has been left between appointments (step 603). Note that schedule conflicts will also be identified in this step.

Preferably controller 101 notifies the user (step 605) if it determines that insufficient travel time has been allotted (step 607) for a specific appointment or if there is an appointment conflict. In some embodiments, notification is sent to the user so that the user can reschedule one or more appointments. Notification may be through interface 105; alternately, a text or email notification message may be sent via system 129 and communication link 119; alternately, notification may be via a phone call and a pre-recorded message.

Hopefully when the user is made aware of a scheduling issue, the user resolves the issue and either cancels an appointment or revises the schedule to avoid the travel time problem. After notification has been sent to the user (step 605), the controller determines whether or not the schedule has been revised (step 609). If the schedule is revised (step 611), then the controller re-calculates whether or not sufficient time has been left between appointments (step 603). If sufficient time has been left between appointments (step 613), then preferably controller 101 adds departure and appointment information to the route information in navigation system 127 (step 615).

It should be understood that some embodiments may bypass (e.g., step 617) step 605 in which the user is notified that there is a potential conflict or that insufficient travel time has been allotted between scheduled appointments. Furthermore, even in those embodiments in which the user is notified of a scheduling issue, the user may not immediately revise the schedule to eliminate the issue (step 619). In those embodiments in which the user is either not notified of a scheduling issue (step 617) or does not immediately resolve the scheduling issue (step 619), preferably controller 101 highlights the problem (step 621) so that when the departure and appointment information is added to the navigation system (step 615) the problem is clearly visible. For example, the scheduling problem may be highlighted by altering the color of that portion of the route which is in issue.

In at least one embodiment, in addition to determining departure times, controller 101 actively reminds the user (step 623) of upcoming departure times to insure that the user is able to be on time to their next appointment. For example, after the controller has added departure and appointment information to the navigation system (step 615), the controller may be configured to send a reminder to the user of an upcoming departure time (step 623). The reminder is typically sent to the user a preset period of time prior to the next scheduled departure time. The system may be configured to allow the manufacturer, a third party or the user to input the preset time period into the system. The reminder may be an internal vehicle reminder, for example a reminder displayed on user interface 105, or an audible reminder utilizing the vehicle's entertainment system (or a separate speaker). Alternately, the reminder may be a text, email, or audible pre-recorded reminder message sent via system 129 and communication link 119. In addition to the reminder message (step 623), or in lieu of the reminder message, controller 101 may also be configured to notify the user if the departure time occurs and the system controller has not yet detected vehicle movement, i.e., the user has not yet departed for their next appointment (step 625). As in the prior step, in step 625 controller issues a reminder message to the user, preferably by sending a text, email, or audible pre-recorded reminder message via system 129 and communication link 119.

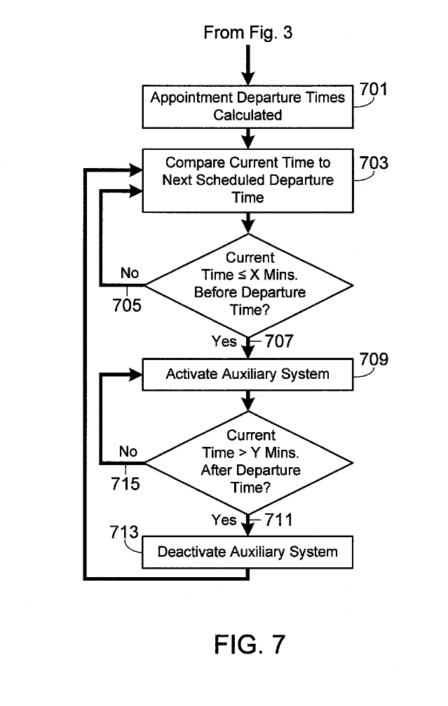

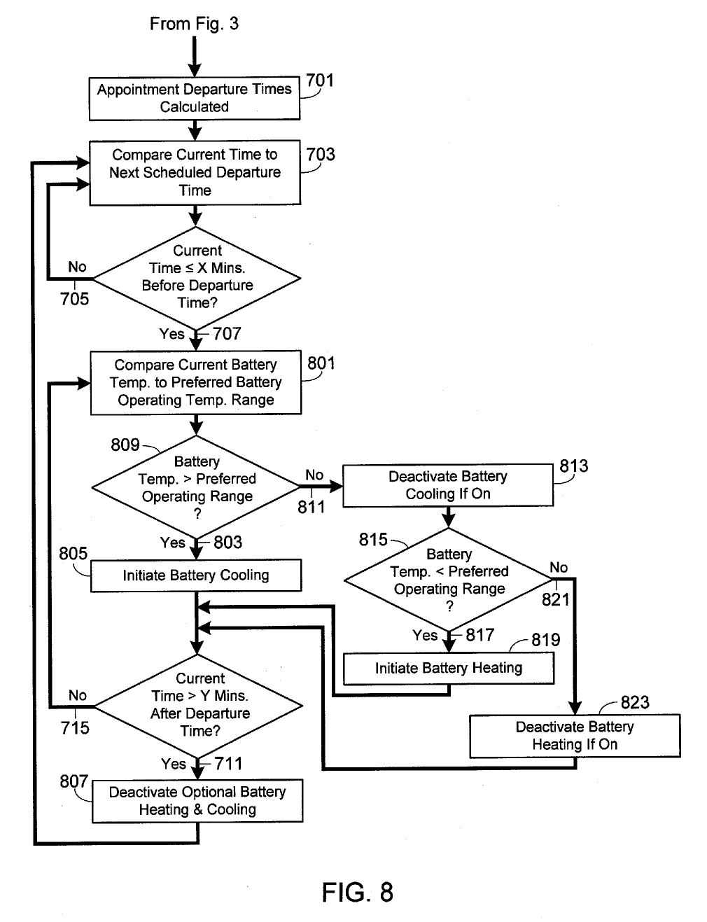

In addition to calculating departure times so that the system can insure that sufficient time has been allotted to travel between appointments, calculated departure times may also be used by the system controller to prepare the vehicle for travel in advance of the actual departure time. As illustrated in FIG. 7, this approach may be used to activate any of a variety of auxiliary systems (e.g., lighting, passenger cabin HVAC system, thermal management system coupled to the vehicle's battery pack or power electronics, etc.) in advance of the departure time, for example by turning on interior or exterior lighting, opening windows, activating cabin heating or cooling, activating battery pack heating or cooling, etc. It will be appreciated that this system is especially useful for an EV where pre-heating or pre-cooling the battery pack may increase efficiency and increase battery life. FIG. 8 illustrates one such battery pack thermal management system. It should be understood that this process may be added to other embodiments, for example the methodologies illustrated in FIGS. 4 and 5, assuming that the departure time is known, e.g., calculated by controller 101.

As shown in FIG. 7, after the system has determined the route (step 323), the system controller then determines departure times for each scheduled appointment (step 701). The calculated departure times calculated by system controller 101 may be based only on the distance to be traveled and a preset average speed; alternately, the calculated departure times may be based on travel distance and an assumed average speed for each type of road; alternately, the calculated departure times may be based on travel distance and the determined speed limit for each road of the route; alternately, the calculated departure times may be based on distance, speed limits, topography (e.g., from topographical data base 131), expected traffic conditions (e.g., from traffic data base 139), and current and/or forecasted weather conditions (e.g., from sensors 133 and/or weather data base 135).

After determining departure times for each appointment, controller 101 compares the current time to the next scheduled departure time (step 703). If the differential between the current time and the next scheduled departure time is greater than a preset time period (step 705), where the preset time period may be set by the manufacturer, a third party or the user, then nothing is done and the system continues to monitor the time and compare it to the next scheduled departure time (step 703). If the differential between the current time and the next scheduled departure time is less than the preset time period (step 707), then the system controller 101 performs a preset task or tasks (step 709), for example by turning on interior or exterior lighting, activating a passenger cabin temperature control system, lowering windows, etc.

In order to prevent excess energy from being wasted and potentially draining the vehicle's batteries, preferably the system is designed to deactivate whatever auxiliary system was activated in step 709. Accordingly, the controller continues to compare the current time to the scheduled departure time. If the current time exceeds the scheduled departure time by a preset time period (step 711), for example due to the driver being delayed in the previous meeting, then the controller is preferably configured to deactivate the previously activated auxiliary system (step 713). If the scheduled departure time has not yet occurred, or if the current time has not exceeded the scheduled departure time by the preset time period (step 715), then the controller simply continues to monitor the time and operate the auxiliary system as pre-programmed.

While the system controller can be configured to perform any of a variety of tasks as noted above, preferably the controller is configured to optimize battery performance for an EV. In the embodiment illustrated in FIG. 8, after it is determined that the differential between the current time and the next scheduled departure time is less than the preset time period (step 707), then the current battery pack temperature is compared to the preferred operating temperature range of the vehicle's batteries (step 801). If the battery temperature is found to be too high (step 803), then the system controller initiates battery cooling (step 805). After initiating battery cooling (step 805), the controller continues to compare the current time to the scheduled departure time as previously described. If the current time exceeds the scheduled departure time by a preset time period (step 711), then the controller is preferably configured to deactivate battery cooling (step 807). If the scheduled departure time has not yet occurred, or if the current time has not exceeded the scheduled departure time by the preset time period (step 715), then the controller simply continues to compare the current battery temperature to the preferred operating range of the battery.

In step 809, if the current battery temperature is lower than the desired operating range (step 811) then the system controller 101 deactivates the optional battery cooling if it was previously initiated (step 813) and compares the current battery pack temperature to the preferred operating temperature range for the batteries (step 815). If the battery temperature is found to be too low (step 817), then the system controller initiates battery heating (step 819). If during step 815 the current battery temperature is higher than the desired operating range (step 821), then the controller deactivates the optional battery heating (step 823) if it was previously initiated. After initiating battery heating (step 819), the controller continues to compare the current time to the scheduled departure time. If the current time exceeds the scheduled departure time by a preset time period (step 711) then the controller is preferably configured to deactivate battery heating (step 807). If the scheduled departure time has not yet occurred, or if the current time has not exceeded the scheduled departure time by the preset time period (step 715), then the controller simply continues to compare the current battery temperature to the preferred operating range of the battery.

In at least one embodiment of the system described above, before activating an auxiliary system (e.g., thermal management system), the controller determines whether the EV is plugged into an external charging source. If the EV is plugged into a charging source, the system controller activates the auxiliary system in accordance with the preset operating instructions, for example using the vehicle's thermal management system to either heat or cool the battery pack as described above. In contrast, however, in this embodiment if the EV is not plugged into a charging source, the system controller does not activate the auxiliary system.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

1. A method of controlling an auxiliary vehicle system integrated into a vehicle, the method comprising the steps of:
coupling a remote system to an on-board system controller, wherein said remote system is physically separate and independent of said vehicle;
synchronizing an on-board calendar with a calendar contained on said remote system, wherein said calendar includes a plurality of successive appointments spanning a period of time, and wherein each appointment of said plurality of successive appointments has a corresponding appointment start time;
determining a plurality of locations corresponding to said plurality of successive appointments;
organizing said driving route, wherein said driving route includes said plurality of locations, and wherein a driving sequence corresponding to said driving route maintains an appointment sequence corresponding to said plurality of successive appointments;
estimating a plurality of successive drive times, wherein each successive drive time of said plurality of successive drive times corresponds to a pair of successive appointments of said plurality of successive appointments;
determining a plurality of successive departure times corresponding to said plurality of successive appointments and incorporating said plurality of successive drive times;
activating said auxiliary vehicle system a preset length of time prior to each successive departure time of said plurality of successive departure times, wherein said activating step is performed automatically by said on-board system controller; and
comparing a current time to each successive departure time of said plurality of successive departure times and for each successive departure time automatically deactivating said auxiliary vehicle system when (i) said current time matches said successive departure time plus a second preset length of time and (ii) said vehicle has not departed.

2. The method of claim 1, wherein said vehicle is an electric vehicle, and wherein said step of activating said auxiliary vehicle system further comprises the step of activating a battery pack cooling subsystem thermally coupled to a vehicle battery pack, wherein said vehicle battery pack is electrically coupled to a vehicle propulsion motor.

3. The method of claim 2, further comprising the steps of:
monitoring a current battery pack temperature; and
comparing said current battery pack temperature to a preferred temperature range, wherein said battery pack cooling subsystem is only activated if said current battery pack temperature exceeds said preferred temperature range.

4. The method of claim 3, further comprising the step of determining if said electric vehicle is plugged into an external charging source, wherein said battery pack cooling subsystem is only activated when said electric vehicle is plugged into said external charging source.

5. The method of claim 1, wherein said vehicle is an electric vehicle, and wherein said step of activating said auxiliary vehicle system further comprises the step of activating a battery pack heating subsystem thermally coupled to a vehicle battery pack, wherein said vehicle battery pack is electrically coupled to a vehicle propulsion motor.

6. The method of claim 5, further comprising the steps of:
monitoring a current battery pack temperature; and
comparing said current battery pack temperature to a preferred temperature range, wherein said battery pack heating subsystem is only activated if said current battery pack temperature is lower than said preferred temperature range.

7. The method of claim 6, further comprising the step of determining if said electric vehicle is plugged into an external charging source, wherein said battery pack heating subsystem is only activated when said electric vehicle is plugged into said external charging source.

8. The method of claim 1, wherein said preset length of time is set by a vehicle manufacturer.

9. The method of claim 1, wherein said preset length of time is set by a third party.

10. The method of claim 1, wherein said preset length of time is user selectable.

11. The method of claim 1, wherein said auxiliary vehicle system is a passenger cabin heating, ventilation and air conditioning system.

12. The method of claim 1, wherein said auxiliary vehicle system is a vehicle lighting system.

13. The method of claim 1, wherein said auxiliary vehicle system controls a plurality of vehicle windows.

14. The method of claim 1, wherein said second preset length of time is set to zero.
